(19) United States
(12) Patent Application Publication
(10) Pub. No.: US 2026/0127606 A1
(43) Pub. Date: May 7, 2026

(54) MACHINE LEARNING MODEL TRAINING USING CONTRASTIVE LANGUAGE ANOMALY PRETRAINING APPROACH

(71) Applicant: eBay Inc., San Jose, CA (US)

(72) Inventors: Zhichao Han, Shanghai (CN); Yang Zhao, Shanghai (CN); Weiming Liang, Shanghai (CN); Yinan Shan, Shanghai (CN); Zitao Zhang, Shanghai (CN); Hang Yin, Shanghai (CN); Shan Jiang, Shanghai (CN); Alok Lal, San Jose, CA (US)

(21) Appl. No.: 18/936,505

(22) Filed: Nov. 4, 2024

(51) Int. Cl. G06Q 20/40; G06N 20/00

(52) U.S. Cl. CPC G06Q 20/4016; G06N 20/00

(57) ABSTRACT

Transaction data associated with a user is identified. A first embedding representing the transaction data is generated using a deep learning machine learning (ML) model. A second embedding interpretable by a large language model is generated using an adaptor ML model based on the first embedding. A text summary associated with one or more transactions is identified. A third embedding representing the text summary is generated using the large language model. An adaptor ML model is trained based on a similarity between the second embedding and the third embedding.

### TECHNICAL FIELD

The present disclosure generally relates to data processing using machine learning technologies. More particularly, various embodiments described herein provide for systems, methods, techniques, instruction sequences, and devices that facilitate machine learning model training using a contrastive language anomaly pretraining approach.

### BACKGROUND

The field of anomaly detection in data science involves identifying unusual patterns in datasets that do not conform to expected behavior. The integration of machine learning with language processing technologies has expanded the scope of data analysis for anomaly detection, allowing for more complex interpretations of structured and unstructured data across a variety of modalities. As technology evolves, the machine learning used in anomaly detection continues to become more refined, leveraging advancements in computational power and algorithmic complexity to improve detection capabilities.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates machine learning model training using a contrastive language anomaly pretraining approach, according to various embodiments of the present disclosure.

FIG. 3 is a flowchart illustrating an example method for facilitating machine learning model training using a contrastive language anomaly pretraining approach, according to various embodiments of the present disclosure.

FIG. 4 is a flowchart illustrating an example method for facilitating machine learning model training using a contrastive language anomaly pretraining approach, according to various embodiments of the present disclosure.

FIG. 5 is a diagram illustrating data flow within an example data management system that facilitates machine learning model training using a contrastive language anomaly pretraining approach, according to various embodiments of the present disclosure.

FIG. 6 is a block diagram illustrating a representative software architecture, which may be used in conjunction with various hardware architectures herein described, according to various embodiments of the present disclosure.

FIG. 7 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate machine learning model training using a contrastive language anomaly pretraining approach, according to various embodiments of the present disclosure. Specifically, various embodiments relate to a Contrastive Language Anomaly Pretraining (CLAP) approach that enhances anomaly detection capabilities. This CLAP approach integrates machine learning models to leverage their advanced processing and reasoning abilities to improve the precision and applicability of anomaly detection across various fields. Anomaly detection is a process used to identify patterns in data that do not conform to expected behavior. These patterns are often indicative of issues such as fraud, system failures, or operational disruptions in industries such as finance, healthcare, and cybersecurity.

Contrastive learning is a technique used in machine learning to learn representations by contrasting positive pairs against negative pairs. In the context of CLAP, this technique helps in aligning the anomaly detection embeddings with the language model embeddings, thereby enhancing the overall understanding and processing capabilities of the system. Specifically, the CLAP approach involves training an adaptor machine learning model (also referred to as an adaptor model or a multimodal adaptor model) that functions as a bridge between domain-specific machine learning models (also referred to as domain models or domain-specific models) and large language models (LLMs). Domain models are trained to process and analyze multimodal data, including tabular data, text, and images, specifically for anomaly detection.

In various embodiments, the adaptor model translates the embeddings generated by the domain models into embeddings in a format that the large language models can interpret. Embeddings refer to numerical representations of data that machine learning models use to understand and process information. By translating (or transforming) these embeddings, the large language models can then apply their advanced processing capabilities to various anomaly detection tasks.

During the training of the adaptor model, the CLAP approach allows comparison between the translated (or transformed) embeddings with embeddings generated by the large language models to evaluate their similarity. Metrics such as cosine similarity or specific loss functions can be used to measure this similarity, which helps in fine-tuning the adaptor model to improve its accuracy.

Once trained, the adaptor model, along with the integrated system, can handle various downstream tasks that go beyond simple anomaly detection. These tasks can include classification, where anomalies are categorized into predefined groups; case summarization, which involves generating concise summaries of detected anomalies; and reporting, where detailed reports are generated based on the anomalies detected.

Overall, various embodiments represent a significant advancement in the field of anomaly detection. By integrating the specialized knowledge of domain-specific models with the advanced language processing capabilities of large language models, these technologies aim to provide more accurate, efficient, and versatile anomaly detection systems. This integration not only helps in improving the detection of anomalies but also enhances the system's ability to understand and interpret the significance of these anomalies in various contexts.

In various embodiments, a data management system identifies transaction data associated with a user. Transaction data can include a variety of information related to a user's purchases and interactions, including, without limitation, user information, transaction details, product information, order information, behavioral data, discounts and offers, feedback and reviews, return and refund information, session data, referral and affiliation data. User information can include user identifiers, names, email addresses, phone numbers, billing and shipping addresses. Transaction details can include transaction identifiers, date and time of the transaction, payment methods (e.g., card, digital payment method), and payment status (e.g., completed, pending, failed). Product information can include product identifiers, product names, categories, quantities purchased, prices per unit, and total cost. Order information can include order identifiers, order status (e.g., placed, shipped, delivered, returned), shipping methods, and tracking numbers. Behavioral data can include items viewed, items added to carts, items removed from carts, and wish list items. Discounts and offers can include coupons or discount codes used, loyalty points, and rewards applied. Feedback and reviews can include product ratings, reviews, and comments. Return and refund information can include return requests, refund amounts, and reasons for return. Session data can include session identifiers, IP addresses, device and browser information, and session duration information. Referral and affiliation data can include referral sources (e.g., social media, email campaigns) and affiliate identifiers (if the user came through an affiliate link).

In various embodiments, the transaction data can include a plurality of paired data between different types of modalities. Example paired data can include tabular-text paired data, tabular-image paired data, video-text paired data, etc. Transaction data can include data points from different modalities, such as texts, graphs, images, data tables, and videos. These paired data (or data sets) can be processed by (and/or used to train) ML models to understand and relate information across these different types of data, enhancing the models'ability to interpret and process multimodal content.

In various embodiments, the data management system uses a deep learning machine learning (ML) model to generate an embedding (e.g., the first embedding) that represents the transaction data. The deep learning ML model can be a domain model specialized in a specific area of expertise, such as anomaly detection. For example, the deep learning model can be tailored to identify fraudulent transactions and/or suspicious users or accounts. The domain model is trained on historical data including both legitimate and fraudulent transactions. The domain model learns to recognize patterns and anomalies that are indicative of fraud, such as unusual transaction amounts, atypical spending behavior, or transactions from unexpected locations. By continually fine-tuning with new data, the domain model can adapt to new fraud techniques and provide real-time alerts to prevent fraudulent activities.

In various embodiments, the deep learning ML model (e.g., domain model) can include (or correspond to) a multi-modal encoder that transforms a plurality of modalities into a shared space for jointly analyzing and processing similarities and relationships between the plurality of modalities. The plurality of modalities can include, without limitation, tabular data, graph data, text data, and image data.

In various embodiments, the data management system uses an adaptor ML model to generate an embedding (e.g., the second embedding) representing the transaction data based on the embedding (e.g., the first embedding) generated by the deep learning ML model. The embedding generated by the adaptor ML model is interpretable by a large language model. In various embodiments, the adaptor ML model acts as a translator (or bridge) that facilitates compatibility between upstream ML models (e.g., domain models) and downstream ML models (e.g., models that consume outputs generated by domain models). In various embodiments, the large language model corresponds to an open-source large language model.

In various embodiments, the data management system identifies a text summary associated with one or more transactions. A text summary in the context of anomaly detection can include various sections (or parts) that provide a comprehensive overview of the analysis based on transaction data associated with a user (e.g., suspicious user) or/or a user account (e.g., suspended user account). For example, a text summary can include one or more of an observation description, a transaction pattern, a fraud risk determination, a confidence score of the fraud risk determination, and a rationale description associated with the fraud risk determination. Each of these sections can be generated via manual (i.e., human) review or by the large language model described herein.

Observation description can explain specific observations related to the transactions. For example, it can describe unusual account activities, such as multiple high-value transactions in a short period or purchases from geographically disparate locations. An example observation description can include, “the community consists of 248 transactions involving the sale of XYZ products, with 265 transactions linked to a single seller. The top linked addresses are all shipping addresses in the same area of Portland, OR, USA. The payment data shows a high volume of failed transactions totaling $211,813.5 over eight days, with only $188,322.5 successfully funded. There are also 23 pending transactions totaling $5,998.35. This pattern of a large number of failed transactions and a smaller number of successful transactions, along with the concentration of transactions with a single seller and shipping addresses, raises suspicion of potentially fraudulent activity. ”

Transaction patterns can identify patterns indicative of fraudulent activity. For example, it can highlight a series of transactions that fit known fraud patterns, such as repeated small withdrawals just below a flagged threshold, or simultaneous logins from different IP addresses. Example transaction patterns can include, “large number of failed transactions, concentration of transactions with a single seller, shipping addresses in the same area.”

Fraud risk determination provides the outcome of the fraud detection analysis, indicating whether the transactions are likely to be fraudulent. For example, it can simply state “fraudulent”(or “1”) or “not fraudulent,” (or “0”).

Confidence score of the fraud risk determination reflects how strongly the data supports the fraud determination. For example, a confidence score of 85% (or 0.85) indicates a high likelihood that the transaction is fraudulent.

Rationale description associated with the fraud risk determination provides an explanation for the fraud risk determination, detailing the factors and data points that led to the conclusion. For example, it can explain that the determination was based on the transaction pattern matching known fraud signatures, the anomaly in user behavior, and other relevant indicators. An example rationale can include, “the large number of failed transactions and the concentration of transactions with a single seller and shipping addresses in the same area suggest that this community may be engaging in fraudulent activity, such as chargebacks or refund fraud. The high volume of failed transactions and the smaller number of successful transactions also indicate potential issues with the legitimacy of the transactions.”

In various embodiments, the data management system uses a large language model to generate an embedding (e.g., the third embedding) that represents the text summary.

In various embodiments, the data management system trains the adaptor ML model based on a similarity between the embedding (e.g., the second embedding) generated by the adaptor ML model and the embedding (e.g., the third embedding) generated by the large language model.

In various embodiments, the data management system uses a cosine similarity formula to determine a value that represents a degree of similarity between the second embedding and the third embedding. The data management system uses the trained adaptor ML model to generate an embedding (e.g., the fourth embedding) representing transaction data of a second user. The data management system generates a text summary of the transaction data based on the fourth embedding.

Reference will now be made in detail to embodiments of the present disclosure, examples of which are illustrated in the appended drawings. The present disclosure may, however, be embodied in many different forms and should not be construed as being limited to the embodiments set forth herein.

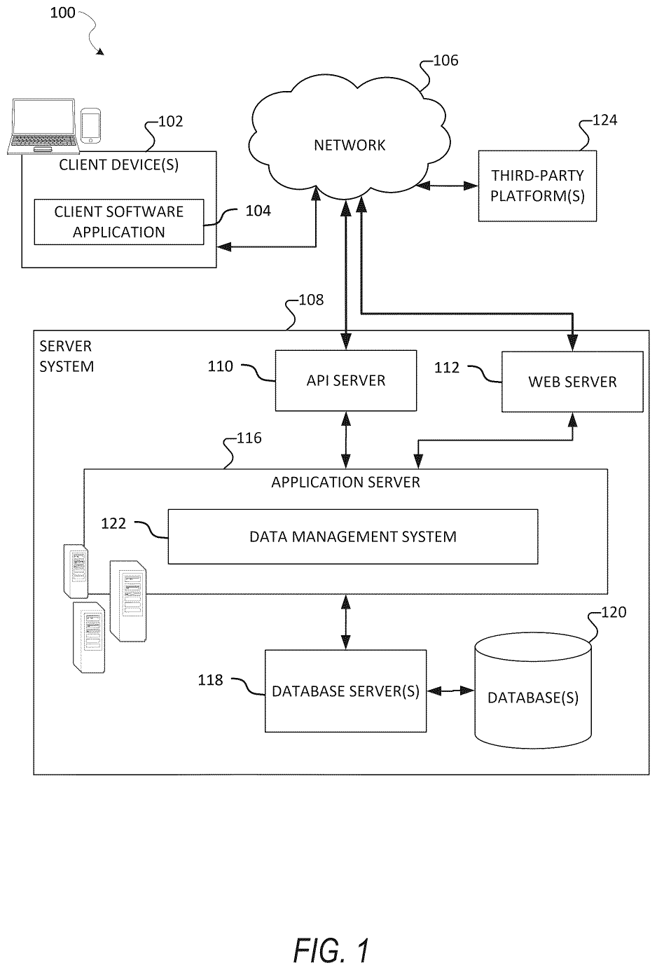

FIG. 1 is a block diagram showing an example data system 100 that includes a data management system 122 (also referred to as system 122), according to various embodiments of the present disclosure. By including the data management system 122, the data system 100 can facilitate machine learning model training using a contrastive language anomaly pretraining approach. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

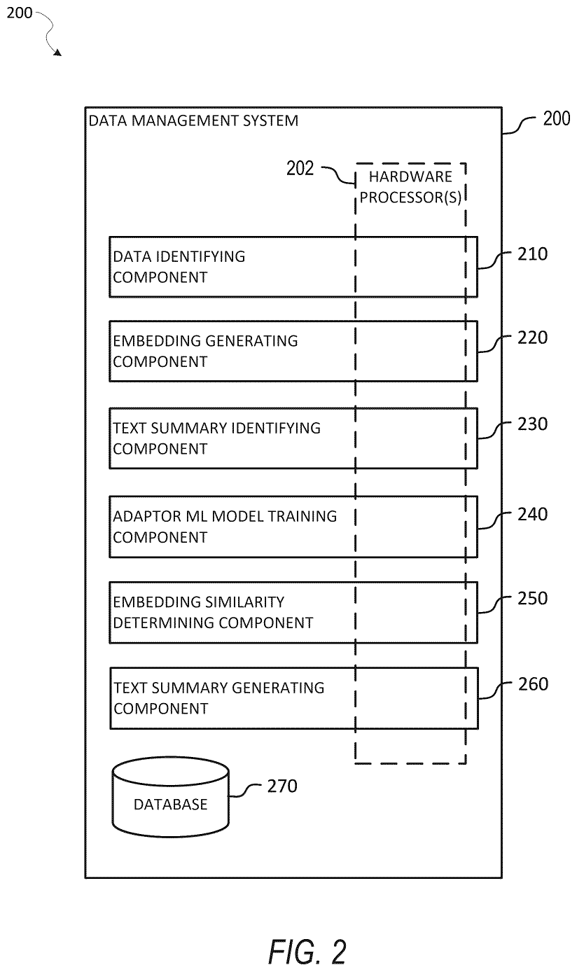

FIG. 2 is a block diagram illustrating an example data management system 200 that facilitates machine learning model training using a contrastive language anomaly pretraining approach, according to various embodiments of the present disclosure. For some embodiments, the data management system 200 represents an example of the data management system 122 described with respect to FIG. 1. As shown, the data management system 200 comprises a data identifying component 210, an embedding generating component 220, a text summary identifying component 230, an adaptor ML model training component 240, an embedding similarity determining component 250, and a text summary generating component 260. According to various embodiments, one or more of the data identifying component 210, the embedding generating component 220, the text summary identifying component 230, the adaptor ML model training component 240, the embedding similarity determining component 250, and the text summary generating component 260 are implemented by one or more hardware processors 202. Data generated by one or more of the data identifying component 210, the embedding generating component 220, the text summary identifying component 230, the adaptor ML model training component 240, the embedding similarity determining component 250, and the text summary generating component 260 may be stored in a database (or datastore) 270 of the data management system 200.

The data identifying component 210 is configured to identify transaction data associated with a user. Transaction data can include a variety of information related to a user's purchases and interactions, including, without limitation, user information, transaction details, product information, order information, behavioral data, discounts and offers, feedback and reviews, return and refund information, session data, referral and affiliation data.

The embedding generating component 220 is configured to use deep learning ML models to generate embeddings that represent transaction data. The embedding generating component 220 is further configured to use an adaptor ML model to generate embeddings representing the transaction data based on the embeddings generated by deep learning ML models described herein. The embedding generating component 220 is further configured to use the trained adaptor ML model to generate embeddings that represent the text summaries described herein.

The text summary identifying component 230 is configured to identify text summaries associated with transactions of a user or a user account. A text summary can include various sections (or parts) that provide a comprehensive overview of the analysis based on transaction data associated with a user (e.g., suspicious user) or/or a user account (e.g., suspended user account). For example, a text summary can include an observation description, a transaction pattern, a fraud risk determination, a confidence score of the fraud risk determination, and a rationale description associated with the fraud risk determination.

The adaptor ML model training component 240 is configured to train the adaptor ML model based on a similarity between the embeddings generated by the adaptor ML model and the embeddings generated by the large language models described herein.

The embedding similarity determining component 250 is configured to use a cosine similarity formula to determine values representing degrees of similarity between embeddings generated by the adaptor ML model and the embeddings generated by the large language models. It should be understood by persons of ordinary skill in the art that other tools and techniques that measure similarity between data points can also be used. Other tools and techniques can include, without limitation, Euclidean Distance, Manhattan Distance, Minkowski Distance, Pearson Correlation Coefficient, Jaccard Similarity, Hamming Distance, Mahalanobis Distance, Kullback-Leibler Divergence, Earth Mover's Distance, Bhattacharyya Distance, Dot Product, etc. Each of these tools and techniques has its own strengths and is suited for different types of data and applications. The choice of similarity measure depends on the specific requirements of the task, including the nature of the data and the desired properties of the similarity measure.

The text summary generating component 260 is configured to use the trained adaptor ML model to generate embeddings representing transaction data of users and/or user accounts.

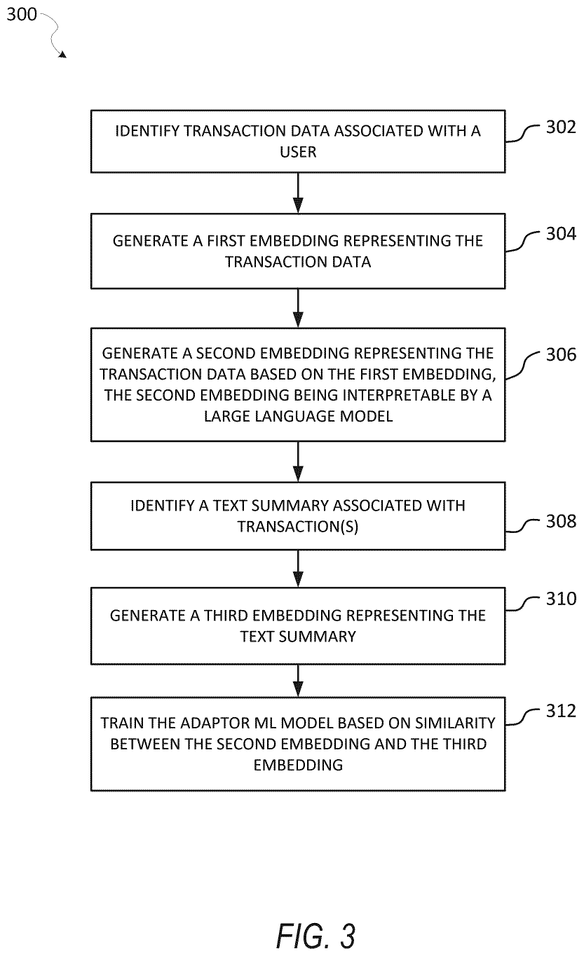

FIG. 3 is a flowchart illustrating an example method 300 for facilitating machine learning model training using a contrastive language anomaly pretraining approach, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300.

Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor identifies transaction data associated with a user. Transaction data can include a variety of information related to a user's purchases and interactions, including, without limitation, user information, transaction details, product information, order information, behavioral data, discounts and offers, feedback and reviews, return and refund information, session data, referral and affiliation data. In various embodiments, the transaction data can include a plurality of paired data between different types of modalities. Example paired data can include tabular-text paired data, tabular-image paired data, video-text paired data, etc. Transaction data can include data points from different modalities, such as texts, graphs, images, data tables, and videos. These paired data (or data sets) can be processed by (and/or used to train) ML models to understand and relate information across these different types of data, enhancing the models'ability to interpret and process multimodal content.

At operation 304, a processor uses a deep learning machine learning (ML) model to generate an embedding (e.g., the first embedding) that represents the transaction data. The deep learning ML model can be a domain model specialized in a specific area of expertise, such as anomaly detection. For example, the deep learning model can be tailored to identify fraudulent transactions and/or suspicious users or accounts. The domain model is trained on historical data including both legitimate and fraudulent transactions. The domain model learns to recognize patterns and anomalies that are indicative of fraud, such as unusual transaction amounts, atypical spending behavior, or transactions from unexpected locations. By continually fine-tuning with new data, the domain model can adapt to new fraud techniques and provide real-time alerts to prevent fraudulent activities.

At operation 306, a processor uses an adaptor ML model to generate an embedding (e.g., the second embedding) representing the transaction data based on the embedding (e.g., the first embedding) generated by the deep learning ML model. The embedding generated by the adaptor ML model is interpretable by a large language model. In various embodiments, the adaptor ML model acts as a translator (or bridge) that facilitates compatibility between upstream ML models (e.g., domain models) and downstream ML models (e.g., models that consume outputs generated by domain models). In various embodiments, the large language model corresponds to an open-source large language model.

At operation 308, a processor identifies one or more text summaries associated with one or more transactions. A text summary can include various sections (or parts) that provide a comprehensive overview of the analysis based on transaction data associated with a user (e.g., suspicious user) or/or a user account (e.g., suspended user account). For example, a text summary can include one or more of an observation description, a transaction pattern, a fraud risk determination, a confidence score of the fraud risk determination, and a rationale description associated with the fraud risk determination.

At operation 310, a processor uses a large language model to generate an embedding (e.g., the third embedding) that represents a text summary.

At operation 312, a processor trains the adaptor ML model based on a similarity between the embedding (e.g., the second embedding) generated by the adaptor ML model and the embedding (e.g., the third embedding) generated by the large language model.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 312 or, alternatively, form part of one or more of operations 302 through 312.

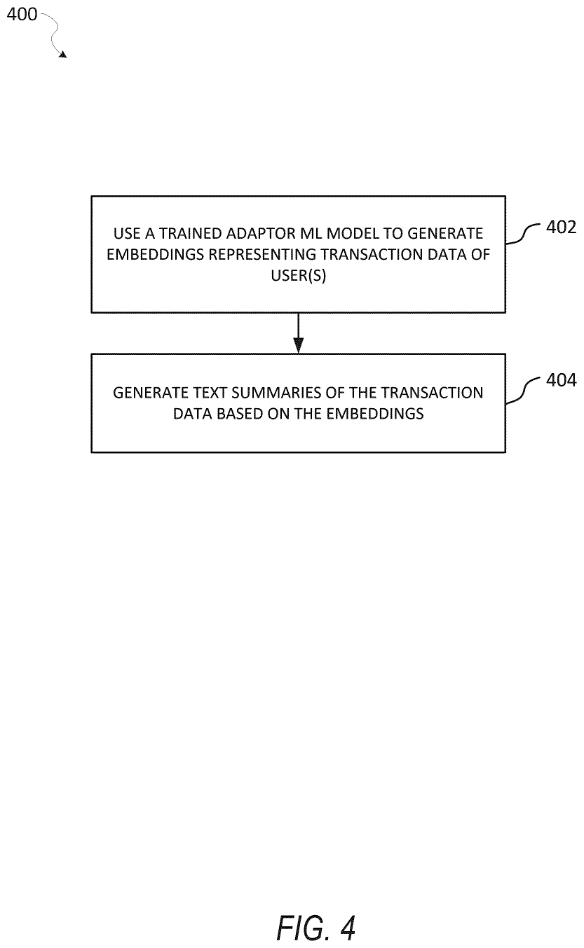

FIG. 4 is a flowchart illustrating an example method 400 for facilitating machine learning model training using a contrastive language anomaly pretraining approach, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor uses the trained adaptor ML model to generate embeddings representing transaction data associated with users (e.g., suspicious) or user accounts (suspended user accounts).

At operation 404, a processor generates text summaries of the transaction data associated with users (e.g., suspicious) or user accounts (suspended user accounts) based on the embeddings generated by the trained adaptor ML model.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 404 or, alternatively, form part of one or more of operations 402 through 404.

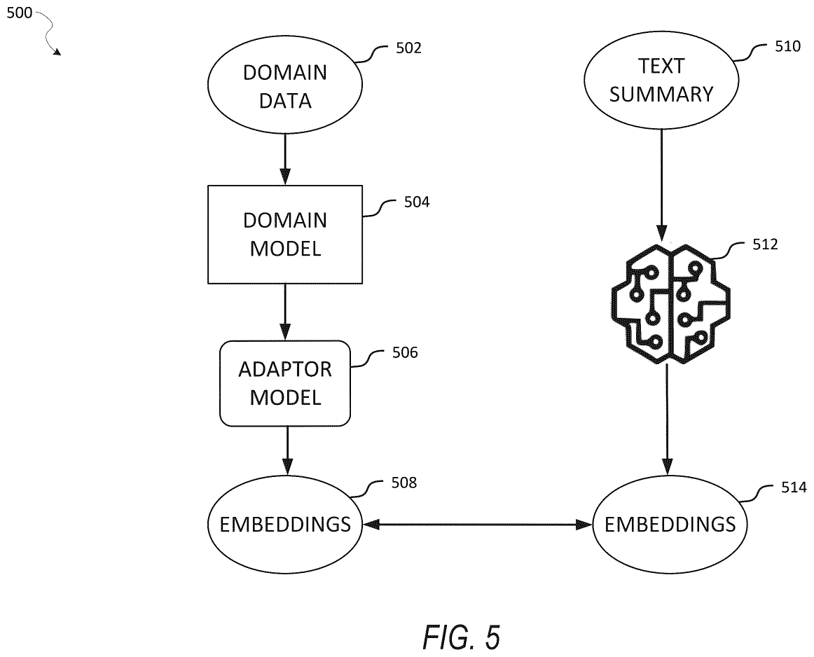

FIG. 5 is a diagram illustrating data flow 500 within an example data management system that facilitates machine learning model training using a contrastive language anomaly pretraining approach, according to various embodiments of the present disclosure. As shown, domain data 502 includes transaction data described herein. Transaction data can include a variety of information related to a user's purchases and interactions. Such a variety of information can be represented by data points from different modalities, such as texts, graphs, images, data tables, and videos, etc. Domain model 504 can correspond to a deep learning machine learning (ML) model described herein. Domain model 504 can be tailored to identify fraudulent transactions and/or suspicious users or accounts. Domain model 504 can be trained on historical data, including both legitimate and fraudulent transactions, to recognize patterns and anomalies that are indicative of fraud, such as unusual transaction amounts, atypical spending behavior, or transactions from unexpected locations. Adaptor model 506 can correspond to a multimodal adaptor ML model that acts as a translator (or bridge) that facilitates compatibility between upstream ML models (e.g., domain model 504) and downstream ML models (e.g., models that consume outputs generated by domain model 504). During the training of the adaptor model 506, the CLAP approach allows comparison between the translated (or transformed) embeddings (e.g., embeddings 508) with embeddings (e.g., embeddings 514) generated by the large language model 512 to evaluate their similarity. Metrics such as cosine similarity or specific loss functions can be used to measure this similarity, which helps in fine-tuning the adaptor model to improve its accuracy.

Text summary 510 can include various sections (or parts) that provide a comprehensive overview of the analysis based on transaction data associated with a user (e.g., suspicious user) or/or a user account (e.g., suspended user account). For example, a text summary can include one or more of an observation description, a transaction pattern, a fraud risk determination, a confidence score of the fraud risk determination, and a rationale description associated with the fraud risk determination. Each of these sections can be generated via manual (i.e., human) review or by the large language model described herein. By training the adaptor model 506 under the CLAP approach described herein, the adaptor model 506 can generate embeddings 508 that are sufficiently similar to embeddings 514, allowing large language models to better understand the anomaly detection embeddings generated by domain model 504 for various downstream tasks. The CLAP approach provides a more effective and efficient way to utilize large language models for anomaly detection and other related tasks.

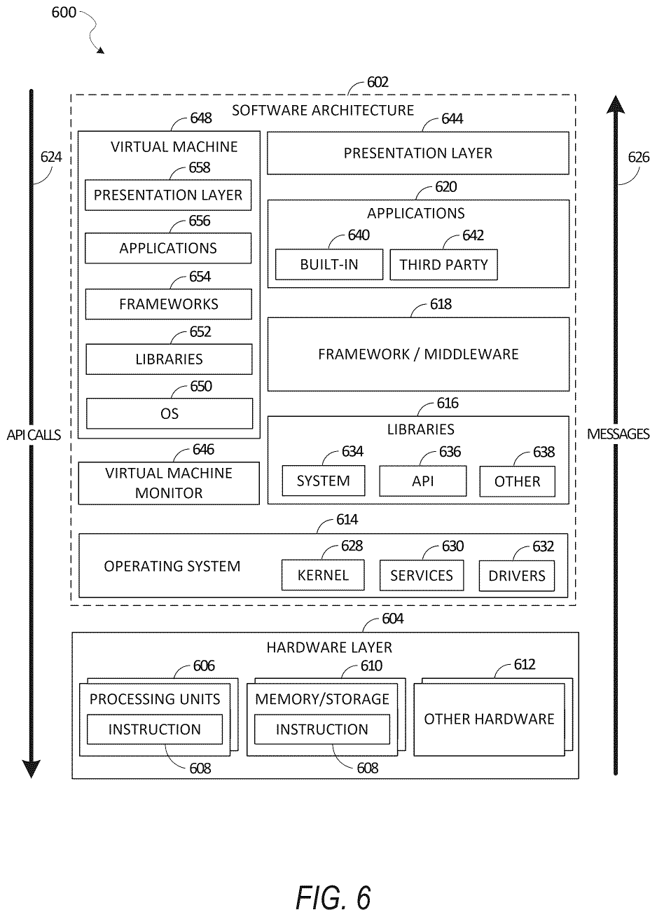

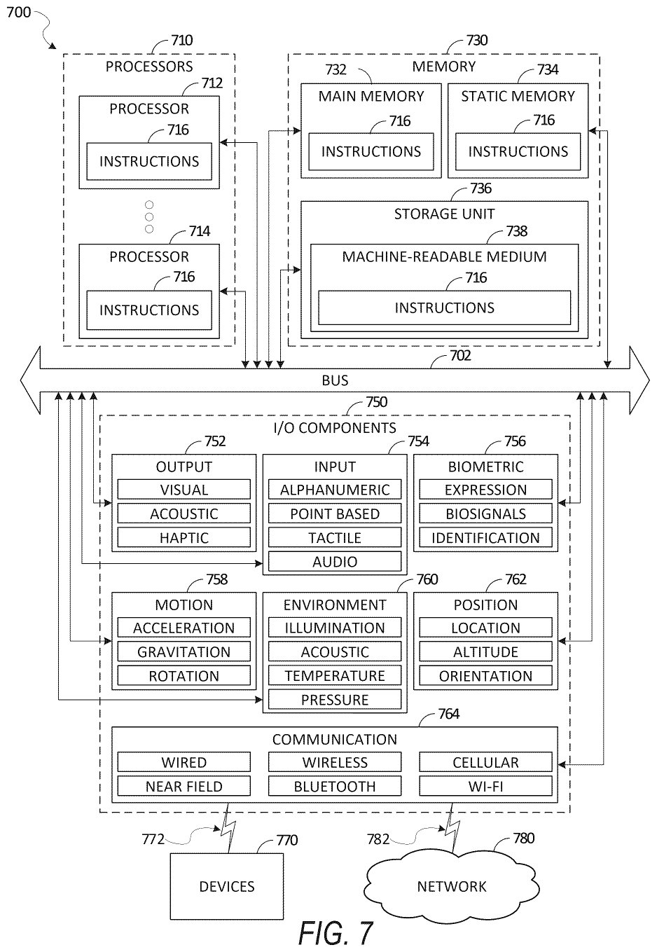

FIG. 6 is a block diagram illustrating an example of a software architecture 602 that may be installed on a machine, according to some example embodiments. FIG. 6 is merely a non-limiting example of a software architecture, and it will be appreciated that many other architectures may be implemented to facilitate the functionality described herein. The software architecture 602 may be executing on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 comprises one or more processing units 606 having associated executable instructions 608. The executable instructions 608 represent the executable instructions of the software architecture 602. The hardware layer 604 also includes memory or storage modules 610, which also have the executable instructions 608. The hardware layer 604 may also comprise other hardware 612, which represents any other hardware of the hardware layer 604, such as the other hardware illustrated as part of the machine 700.

In the example architecture of FIG. 6, the software architecture 602 may be conceptualized as a stack of layers, where each layer provides particular functionality. For example, the software architecture 602 may include layers such as an operating system 614, libraries 616, frameworks/middleware 618, applications 620, and a presentation layer 644. Operationally, the applications 620 or other components within the layers may invoke API calls 624 through the software stack and receive a response, returned values, and so forth (illustrated as messages 626) in response to the API calls 624. The layers illustrated are representative in nature, and not all software architectures have all layers. For example, some mobile or special-purpose operating systems may not provide a frameworks/middleware 618 layer, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than by interfacing directly with the underlying operating system 614 functionality (e.g., kernel 628, services 630, or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 or other software components/modules. For example, the frameworks 618 may provide various graphical user interface functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a home application, a contacts application, a browser application, a book reader application, a location application, a media application, a messaging application, or a game application.

The third-party applications 642 may include any of the built-in applications 640, as well as a broad assortment of other applications. In a specific example, the third-party applications 642 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 642 may invoke the API calls 624 provided by the mobile operating system such as the operating system 614 to facilitate functionality described herein.

The applications 620 may utilize built-in operating system functions (e.g., kernel 628, services 630, or drivers 632), libraries (e.g., system libraries 634, API libraries 636, and other libraries 638), or frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with the user.

Some software architectures utilize virtual machines. In the example of FIG. 6, this is illustrated by a virtual machine 648. The virtual machine 648 creates a software environment where applications/modules can execute as if they were executing on a hardware machine (e.g., the machine 600 of FIG. 6). The virtual machine 648 is hosted by a host operating system (e.g., the operating system 614) and typically, although not always, has a virtual machine monitor 646, which manages the operation of the virtual machine 648 as well as the interface with the host operating system (e.g., the operating system 614). A software architecture executes within the virtual machine 648, such as an operating system 650, libraries 652, frameworks 654, applications 656, or a presentation layer 658. These layers of software architecture executing within the virtual machine 648 can be the same as corresponding layers previously described or may be different.

FIG. 7 illustrates a diagrammatic representation of a machine 700 in the form of a computer system within which a set of instructions may be executed for causing the machine 700 to perform any one or more of the methodologies discussed herein, according to an embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the method 300 described above with respect to FIG. 3 and the method 400 described above with respect to FIG. 4. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an embodiment, the processors 710 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736 including machine-readable medium 738, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In some examples, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 750 may include biometric components 756, motion components 758, environmental components 760, or position components 762, among a wide array of other components. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 700 including processors 710), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 700, but deployed across a number of machines 700. In some example embodiments, the processors 710 or processor-implemented modules are located in a single geographic location (e.g., within a home environment, an office environment, or a server farm). In other example embodiments, the processors or processor-implemented modules are distributed across a number of geographic locations.

The various memories (i.e., 730, 732, 734, and/or the memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 780 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more hardware processors; and
at least one machine-storage medium for storing instructions that, when executed by the one or more hardware processors, cause the one or more hardware processors to perform operations comprising:
identifying transaction data associated with a user;
generating, using a deep learning machine learning (ML) model, a first embedding that represents the transaction data;
generating, using an adaptor ML model, a second embedding that represents the transaction data based on the first embedding, the second embedding being interpretable by a large language model;
identifying a text summary associated with one or more transactions;
generating, using the large language model, a third embedding that represents the text summary; and
training the adaptor ML model based on a similarity between the second embedding and the third embedding.

2. The system of claim 1, wherein the deep learning ML model comprises a multi-modal encoder that transforms a plurality of modalities into a shared space for jointly analyzing and processing similarities and relationships between the plurality of modalities.

3. The system of claim 2, wherein the plurality of modalities comprises one or more of tabular data, graph data, text, and images.

4. The system of claim 1, wherein the adaptor ML model facilitates compatibility between upstream ML models and downstream ML models.

5. The system of claim 1, the training of the adaptor ML model based on the similarity between the second embedding and the third embedding comprises:
determining, using a cosine similarity formula, a value that represents a degree of similarity between the second embedding and the third embedding.

6. The system of claim 1, wherein the user is a first user, and wherein the operations comprise:
using a trained adaptor ML model to generate a fourth embedding representing transaction data of a second user; and
generating a text summary of the transaction data based on the fourth embedding.

7. The system of claim 1, wherein the text summary of the transaction data comprises at least one of an observation description, a transaction pattern, a fraud risk determination, a confidence score of the fraud risk determination, and a rationale description associated with the fraud risk determination, and wherein one or more of the observation description, the transaction pattern, the fraud risk determination, the confidence score of the fraud risk determination, and the rationale description associated with the fraud risk determination are generated via manual review.

8. The system of claim 1, wherein the large language model corresponds to an open-source large language model.

9. The system of claim 1, wherein the transaction data comprises a plurality of paired data between different types of modalities.

10. The system of claim 1, wherein the text summary associated with one or more transactions corresponds to one or more suspended user accounts.

11. A method comprising:
identifying transaction data associated with a user;
generating, using a deep learning machine learning (ML) model, a first embedding that represents the transaction data;
generating, using an adaptor ML model, a second embedding that represents the transaction data based on the first embedding, the second embedding being interpretable by a large language model;
identifying a text summary associated with one or more transactions;
generating, using the large language model, a third embedding that represents the text summary; and
training the adaptor ML model based on a similarity between the second embedding and the third embedding.

12. The method of claim 11, wherein the deep learning ML model comprises a multi-modal encoder that transforms a plurality of modalities into a shared space for jointly analyzing and processing similarities and relationships between the plurality of modalities.

13. The method of claim 12, wherein the plurality of modalities comprises one or more of tabular data, graph data, text, and images.

14. The method of claim 11, wherein the adaptor ML model facilitates compatibility between upstream ML models and downstream ML models.

15. The method of claim 11, the training of the adaptor ML model based on the similarity between the second embedding and the third embedding comprises:
determining, using a cosine similarity formula, a value that represents a degree of similarity between the second embedding and the third embedding.

16. The method of claim 11, wherein the user is a first user, comprising:
using a trained adaptor ML model to generate a fourth embedding representing transaction data of a second user; and
generating a text summary of the transaction data based on the fourth embedding.

17. The method of claim 11, wherein the text summary of the transaction data comprises at least one of an observation description, a transaction pattern, a fraud risk determination, a confidence score of the fraud risk determination, and a rationale description associated with the fraud risk determination, and wherein one or more of the observation description, the transaction pattern, the fraud risk determination, the confidence score of the fraud risk determination, and the rationale description associated with the fraud risk determination are generated via manual review.

18. The method of claim 11, wherein the large language model corresponds to an open-source large language model.

19. The method of claim 11, wherein the transaction data comprises a plurality of paired data between different types of modalities, and wherein the text summary associated with one or more transactions corresponds to one or more suspended user accounts.

20. A machine-storage medium for storing instructions that, when executed by one or more hardware processors, cause the one or more hardware processors to perform operations comprising:
identifying transaction data associated with a user;
generating, using a deep learning machine learning (ML) model, a first embedding that represents the transaction data;
generating, using an adaptor ML model, a second embedding that represents the transaction data based on the first embedding, the second embedding being interpretable by a large language model;
identifying a text summary associated with one or more transactions;
generating, using the large language model, a third embedding that represents the text summary; and
training the adaptor ML model based on a similarity between the second embedding and the third embedding.
